(19) United States
(12) Patent Application Publication
(10) Pub. No.: US 2008/0261000 A1
(43) Pub. Date: Oct. 23, 2008

(54) Laminate chair mat

(76) Inventors: Charles J. White, Lancaster, PA (US); Mark L. Orr, Lancaster, PA (US)

Correspondence Address: Douglas E. Winters;Armstrong World Industries, Inc., 2500 Columbia Avenue, P.O. Box 3001, Lancaster, PA, 17604-3001, US

(21) Appl. No.: 11/788,425

(22) Filed: Apr. 20, 2007

(51) Int. Cl. B32B 23/02; B32B 7/12

(52) U.S. Cl. 428/192; 156/327

(57) ABSTRACT

A laminate mat, particularly a chair mat, comprises a wear layer, a decorative layer and a transparent or translucent wear layer. Each of the layers is formed from a plurality of resin impregnated papers. A resin impregnated decal may be interposed between the decorative layer and the wear layer to personalize the mat. The peripheral edges of the mat are routed to form a beveled or rounded configuration and paint, ink or a film is applied to the beveled or rounded peripheral edges.

The present invention relates generally to the field of floor products. More particularly, the present invention relates to a laminate mat, and more particularly to a laminate chair mat and a method of making the laminate mat and laminate chair mat.

### BACKGROUND OF THE INVENTION

Office chairs are often provided with casters to allow the user to roll the chair while seated. To lower rolling resistance and to protect the floor from wear, it is common to use a chair mat. A conventional chair mat is typically constructed of a clear or translucent sheet vinyl material (pliable or rigid) having a relatively smooth upper surface and a bottom surface optionally provided with a plurality of integrally molded spikes for engaging a carpeted floor. Such chair mats typically have a polyvinyl or polyurethane wear layer.

One of the drawbacks of such conventional vinyl chair mats is that the vinyl tends to crack over time, losing its integrity. Besides being aesthetically unpleasing, conventional chair mats commonly become fragmented along the cracks so that pieces of the mat can become detached, exposing the flooring below.

Chair mats comprising a carpet layer on the appearance side are also known. Such carpeted chair mats, however, do not allow the casters to roll as easily as on a smooth, hard surface.

It would therefore be desirable to provide a chair mat which is more durable than plastic and wood chair mats and has a smooth hard surface that is aesthetically pleasing and capable of blending in with the existing office furniture, and is resistant to the deterioration that adversely affects conventional vinyl or wood chair mats. Preferably, the chair mat could be personalized with a design element.

### SUMMARY OF THE INVENTION

The present invention provides a very durable mat, particularly a chair mat, having a resin impregnated paper laminate construction comprising a balancing layer, a decorative layer and a transparent or translucent wear layer. In a preferred embodiment, a resin impregnated paper decal is interposed between the decorative layer and the wear layer forming a discontinuous decorative layer, which can be used to personalize the chair mat. While other shapes including round mats and generally rectangular mats are included within the scope of the present invention, the preferred shape is a mat having a generally rectangular shape with a lip or tongue portion.

The present invention is also directed to a method of making a resin impregnated paper laminate mat or laminate chair mat. A laminate sheet of resin impregnated paper layers is formed by laminating a balancing, a decorative layer and a transparent or translucent wear layer. The generally rectangular shaped pieces are punched or cut out of the laminate sheet and the edges are then beveled or rounded by routing or other means to form a beveled or rounded configuration.

### BRIEF DESCRIPTION OF THE DRAWINGS

FIG. 1 is a plan view of a chair mat of the present invention; and

FIG. 2 is a cross sectional view of the chair mat of FIG. 1 taken along line 2-2.

### DETAILED DESCRIPTION OF THE INVENTION

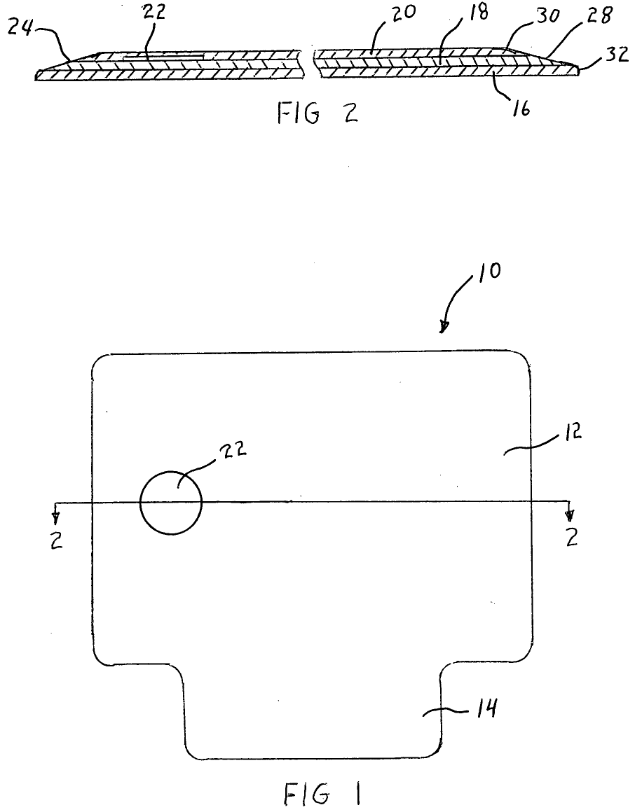

The chair mat 10 shown in FIG. 1 has a generally rectangular body 12 with a lip or tongue portion 14. The chair mat can be of any size that will accommodate a chair having roller castors and is generally about 3′ to about 4′ wide by about 3′ to about 4′ in depth with a lip or tongue portion about 20″ to about 30″ wide by about 6″ to about 12″ in depth.

As shown in FIG. 2, the mat 10 comprises a balancing layer 16 underlying a decorative layer 18 which underlies a transparent or translucent wear layer 20. Each of the layers is formed from a plurality of resin impregnated papers typically associated with high density fiberboard (HDF) or medium density fiberboard (MDF). If desired, additional layers can be included in the structure. Therefore, while the wear layer, decorative layer and balancing layer overlie one another, they may not be in contact one with another.

The decorative layer 18 may have the appearance of wood, a solid color, marble, ceramic tile, stone, slate, brick or a fanciful pattern. To personalize the matt, a decal 22 can be interposed between the decorative layer and the wear layer. The decal may have the appearance of a sports logo, a cartoon character, a university logo, a floral design or animals, for example. The decal 22 forms a discontinuous decorative layer between the continuous decorative layer 18 and the wear layer 20.

The preferred structure of the decal 20 is that of a resin impregnated paper. It has been found that a vinyl film decal melts and distorts as the mat is laminated and that a paper that is too thick leads to ledging and cracks.

Rather than being an assembly of a plurality of laminate pieces or planks, the matt of the present invention is a single monolithic piece. The laminate planks of the prior art are formed with tongue and groove edges that assist in assembling the planks into a floor.

The laminate mat of the present invention has edge portions 24 that are rounded or beveled. This enables the chair to more easily roll on or off the mat. However, since a portion of the decorative layer is removed in forming the rounded edge or bevel, it is necessary to paint, print or cover the edge portions with a film. Typically, the film would be adhered to the mat edge with an adhesive.

One preferred edge is the beveled ramp 26 shown in FIG. 2. One end 28 of the bevel is located adjacent the upper exposed surface 30 of the mat and the other end 32 of the bevel terminates in a half bullnose edge. The intersection of bevel and the upper surface is rounded, as is the intersection of the bevel and the vertical surface at the edge of the matt. The thickness of the bullnose is sufficient to deter chipping and cracking of the mat edge.

The laminate mat is made by forming a sheet of laminated resin impregnated paper layers. The layers include a balancing layer, a decorative layer and a transparent or translucent wear layer. Each of the layers is a plurality of resin impregnated paper layers. The mat is then punched or cut out of the sheet and a portion of the peripheral edges of the mat are removed to form a beveled or rounded configuration. Preferably the edge portion is routed to form a beveled ramp with a half bullnose edge. The beveled or rounded edge is then covered with paint, ink or a film to hide the exposed balancing layer.

If desired, a resin impregnated decal is interposed between the decorative layer and the wear layer prior to laminating the layers together. This forms a discontinuous decorative layer between the continuous decorative layer and the continuous wear layer.

1. A laminated chair mat comprising a monolithic sheet of laminated resin impregnated paper layers, the laminated layers comprising a balancing layer, a decorative layer and a transparent or translucent wear layer, the wear layer overlying the decorative layer and the decorative layer overlying the balancing layer, each of the layers being a resin impregnated paper layer, the peripheral edges of the mat having a beveled or rounded configuration.

2. The laminated chair mat of claim 1, wherein the decorative layer has a design selected from the group consisting of a wood pattern, a solid color, a marble pattern, a ceramic tile pattern, a stone pattern, a slate pattern, a brick and a fanciful pattern.

3. The laminated chair mat of claim 1, wherein the laminated sheet further comprises a resin impregnated paper decal forming a discontinuous layer interposed between the decorative layer and the wear layer.

4. The laminated chair mat of claim 3, wherein the decal is selected from the group consisting of a sports logo, a cartoon character, a university logo, a floral design and animals.

5. The laminated chair mat of claim 1, wherein the peripheral edges have a beveled ramp configuration with a half bullnose edge.

6. (canceled)

7. The laminated chair mat of claim 1, wherein the laminated mat is a laminate chair mat having a generally rectangular body and a tongue portion extending from the body.

8. A method of making a plurality of laminated chair mats comprising
a) forming a sheet of laminated resin impregnated paper layers by laminating a plurality of resin impregnated paper layers, the layers comprising a balancing layer, a decorative layer and a transparent or translucent wear layer,
b) cutting the laminate sheet into a plurality of monolithic chair mats having a generally rectangular bodies and a tongue portions extending from the bodies, and
c) adhering paint, ink or a film to the peripheral edges.

9. The method of claim 8, further comprising interposing a resin impregnated paper decal between the decorative layer and the wear layer prior to laminating the layers together, thereby forming a discontinuous layer interposed between the decorative layer and the wear layer.

10. The method of claim 8, further comprising routing the peripheral edges to form a beveled ramp configuration with a half bullnose edge.

11. The method of claim 8, further comprising removing a portion of the peripheral edges of the monolithic chair mats to form beveled or rounded configurations.

12. (canceled)

13. A laminate mat comprising a monolithic sheet of laminated resin impregnated paper layers, the laminated layers comprising a balancing layer, a decorative layer and a transparent or translucent wear layer, the wear layer overlying the decorative layer and the decorative layer overlying the balancing layer, each of the layers being a resin impregnated paper layer, wherein the peripheral edges are covered with paint, ink or a film.

14. The laminated chair mat of claim 13, wherein the decorative layer has a design selected from the group consisting of a wood pattern, a solid color, a marble pattern, a ceramic tile pattern, a stone pattern, a slate pattern, a brick and a fanciful pattern.

15. The laminated chair mat of claim 13, wherein the laminated sheet further comprises a resin impregnated paper decal forming a discontinuous layer interposed between the decorative layer and the wear layer.

16. The laminated chair mat of claim 15, wherein the decal is selected from the group consisting of a sports logo, a cartoon character, a university logo, a floral design and animals.

17. The laminated chair mat of claim 1, wherein the peripheral edges of the mat have a beveled or rounded configuration.

18. The laminated chair mat of claim 1, wherein the peripheral edges have a beveled ramp configuration with a half bullnose edge.

19. The laminated chair mat of claim 1, wherein the laminated mat is a laminate chair mat having a generally rectangular body and a tongue portion extending from the body.
